(19) United States
(12) Patent Application Publication
(10) Pub. No.: US 2017/0144643 A1
(43) Pub. Date: May 25, 2017

(54) ELECTRIC BRAKE SYSTEM

(71) Applicant: MANDO CORPORATION, Gyeonggi-do (KR)

(72) Inventors: Gi-Yung KIM, Gyeonggi-do (KR); Seong-Ho CHOI, Gyeonggi-do (KR); Dong-Yo RYU, Gyeonggi-do (KR); Yong-Kap KIM, Gyeonggi-do (KR); Weon-Chan KO, Gyeonggi-do (KR); Hyun-Ho KIM, Gyeonggi-do (KR); Eun-Seong LIM, Gyeonggi-do (KR); ln-Wook JEON, Seoul (KR); Yeong-Sik KIM, Gyeonggi-do (KR); Byong-Hoo CHEONG, Gyeonggi-do (KR)

(21) Appl. No.: 15/355,063

(22) Filed: Nov. 18, 2016

(30) Foreign Application Priority Data
Nov. 19, 2015 (KR) 10-2015-0162412

(51) Int. Cl. B60T 13/74; B60T 7/04; B60T 13/68

(52) U.S. Cl. CPC B60T 13/745; B60T 13/686; B60T 7/042; B60T 2270/82

(57) ABSTRACT

An electric brake system is disclosed. The electric brake system includes a master cylinder, a pedal displacement sensor configured to sense a displacement of a brake pedal, a hydraulic pressure supply device configured to generate hydraulic pressure using a piston which is operated by means of an electrical signal that is output corresponding to the displacement of the brake pedal, a first hydraulic flow path configured to communicate with first pressure chamber, a second hydraulic flow path configured to communicate with second pressure chamber, a first control valve provided at the first hydraulic flow path, a second control valve provided at the second hydraulic flow path, a first hydraulic circuit including first and second branching flow paths which branch from the first hydraulic flow path, a second hydraulic circuit including third and fourth branching flow paths which branch from the second hydraulic flow path, a first backup flow path configured to communicate the first hydraulic port with the first hydraulic flow path, a second backup flow path configured to communicate the second hydraulic port with the second pressure chamber, a first cut valve provided at the first backup flow path, a second cut valve provided at the second backup flow path, and a simulation device provided at a flow path branching from the first backup flow path configured with a simulator valve provided at a flow path connecting a simulation chamber configured to store oil therein to the reservoir, and configured to provide a reaction force according to the pedal effort of the brake pedal.

This application claims the benefit of Korean Patent Application No. 2015-0162412, filed on Nov. 19, 2015 in the Korean Intellectual Property Office, the disclosure of which is incorporated herein by reference.

### BACKGROUND

1. Field

Embodiments of the present disclosure relate to an electric brake system, and more particularly, to an electric brake system generating a braking force using an electrical signal corresponding to a displacement of a brake pedal.

2. Description of the Related Art

A brake system for braking is necessarily mounted on a vehicle, and a variety of systems for providing stronger and more stable braking have been proposed recently.

For example, there are brake systems including an anti-lock brake system (ABS) for preventing a wheel from sliding while braking, a brake traction control system (BTCS) for preventing a driving wheel from slipping when a vehicle is unintentionally or intentionally accelerated, an electronic stability control (ESC) system for stably maintaining a driving state of a vehicle by combining an ABS with traction control to control hydraulic pressure of a brake, and the like.

Generally, an electric brake system includes a hydraulic pressure supply device which receives a braking intent of a driver in the form of an electrical signal from a pedal displacement sensor which senses a displacement of a brake pedal when the driver steps on the brake pedal and then supplies hydraulic pressure to a wheel cylinder.

An electric brake system provided with such a hydraulic pressure supply device is disclosed in European Registered Patent No. EP 2 520 473. According to the disclosure in that document, the hydraulic pressure supply device is configured such that a motor is activated according to a pedal effort of a brake pedal to generate braking pressure. At this point, the braking pressure is generated by converting a rotational force of the motor into a rectilinear movement to pressurize a piston.

### PRIOR ART DOCUMENT

(Patent Document) European Registered Patent No. EP 2 520 473 A1 (Honda Motor Co., Ltd.), Nov. 7, 2012.

### SUMMARY

Therefore, it is an aspect of the present disclosure to provide an electric brake system including a tandem type hydraulic pressure supply device capable of accomplishing a balance in pressure among a plurality of chambers.

Also, it is another aspect of the present disclosure to provide an electric brake system capable of inspecting occurrence of a leak at a valve.

Additional aspects of the disclosure will be set forth in part in the description which follows and, in part, will be obvious from the description, or may be learned by practice of the disclosure.

In accordance with one aspect of the present invention, there may be provided an electric brake system, which comprises a master cylinder at which first and second hydraulic ports are formed, connected to a reservoir configured to store oil, and having one or more pistons to discharge oil according to a pedal effort of a brake pedal, a pedal displacement sensor configured to sense a displacement of the brake pedal, a hydraulic pressure supply device configured to generate hydraulic pressure using a piston which is operated by means of an electrical signal that is output corresponding to the displacement of the brake pedal, and including a cylinder block, first and second pistons movably accommodated inside the cylinder block, a first pressure chamber provided at a front side of the first piston and connected to one or more wheel cylinders, and a second pressure chamber provided at a front side of the second piston and connected to the one or more wheel cylinders, a first hydraulic flow path configured to communicate with the first pressure chamber, a second hydraulic flow path configured to communicate with the second pressure chamber, a first control valve provided at the first hydraulic flow path and configured to control an oil flow, a second control valve provided at the second hydraulic flow path and configured to control an oil flow, a first hydraulic circuit including first and second branching flow paths which branch from the first hydraulic flow path and are connected to two wheel cylinders, respectively, a second hydraulic circuit including third and fourth branching flow paths which branch from the second hydraulic flow path and are connected to two wheel cylinders, respectively, a first backup flow path configured to communicate the first hydraulic port with the first hydraulic flow path and connected to a downstream side of the first control valve, a second backup flow path configured to communicate the second hydraulic port with the second pressure chamber and connected to a downstream side of the second control valve, a first cut valve provided at the first backup flow path and configured to control an oil flow, a second cut valve provided at the second backup flow path and configured to control an oil flow, and a simulation device provided at a flow path branching from the first backup flow path, configured with a simulator valve provided at a flow path connecting a simulation chamber configured to store oil therein to the reservoir, and configured to provide a reaction force according to the pedal effort of the brake pedal.

Also, the electric brake system may further include a first inlet valve provided at the first branching flow path and configured to control an oil flow, a second inlet valve provided at the second branching flow path and configured to control an oil flow, a third inlet valve provided at the third branching flow path and configured to control an oil flow, and a fourth inlet valve provided at the fourth branching flow path and configured to control an oil flow.

Also, the first to fourth inlet valves may be configured with a solenoid valve configured to control bidirectionally an oil flow between the hydraulic pressure supply device and the one or more wheel cylinders.

Also, the first to fourth inlet valves may be a normally opened type valve that is usually open and is closed when a closing signal is received.

Also, the first control valve may be configured with a check valve configured to allow an oil flow in a direction from the first pressure chamber toward the first hydraulic circuit and block an oil flow in a reverse direction, and the second control valve may be configured with a check valve configured to allow an oil flow in a direction from the second pressure chamber toward the second hydraulic circuit and block an oil flow in a reverse direction.

Also, the electric brake system may further include a first dump flow path configured to communicate with the first pressure chamber and connected to the reservoir, a second dump flow path configured to communicate with the second pressure chamber and connected to the reservoir, a first dump valve provided at the first dump flow path, configured to control an oil flow, and configured with a check valve configured to allow an oil flow in a direction from the reservoir to the first pressure chamber and block an oil flow in a reverse direction, and a second dump valve provided at the second dump flow path, configured to control an oil flow, and configured with a check valve configured to allow an oil flow in a direction from the reservoir to the second pressure chamber and block an oil flow in a reverse direction.

Also, the first dump flow path may branch from an upstream side of the first control valve at the first hydraulic flow path, and the second dump flow path may branch from an upstream side of the second control valve at the second hydraulic flow path.

Also, the electric brake system may further include a third control valve provided at a bypass flow path connecting an upstream side of the first control valve and a downstream side thereof at the first hydraulic flow path and configured with a solenoid valve configured to control bidirectionally an oil flow between the first pressure chamber and the first hydraulic circuit, and a fourth control valve provided at a bypass flow path connecting an upstream side of the second control valve and a downstream side thereof at the second hydraulic flow path and configured with a solenoid valve configured to control bidirectionally an oil flow between the second pressure chamber and the second hydraulic circuit.

Also, the third and fourth control valves may be a normally closed type valve that is usually closed and is open when an opening signal is received.

Also, the electric brake system may further include a third hydraulic flow path configured to communicate the first hydraulic flow path and the second hydraulic flow path and connect a downstream side of the first control valve to a downstream side of the second control valve, and a circuit balance valve provided at the third hydraulic flow path and configured to control an oil flow.

Also, the circuit balance valve may be configured with a solenoid valve configured to control bidirectionally an oil flow between the first hydraulic flow path and the second hydraulic flow path.

Also, the circuit balance valve may be a normally closed type valve that is usually closed and is open when an opening signal is received.

### BRIEF DESCRIPTION OF THE DRAWINGS

FIG. 1 is a hydraulic circuit diagram illustrating a non-braking state of an electric brake system according to an embodiment of the present disclosure.

FIG. 2 is a diagram illustrating a structure of a hydraulic pressure supply unit.

FIG. 3 is a hydraulic circuit diagram illustrating a state in which an electric brake system according to an embodiment of the present disclosure performs a braking operation normally.

FIG. 4 is a hydraulic circuit diagram illustrating a state in which braking is released while an electric brake system according to an embodiment of the present disclosure operates normally.

FIG. 5 is a hydraulic circuit diagram illustrating a state in which an anti-lock brake system (ABS) is operated through an electric brake system according to an embodiment of the present disclosure.

FIG. 6 is a hydraulic circuit diagram illustrating a state in which an electric brake system according to an embodiment of the present disclosure supplements hydraulic pressure.

FIG. 7 is a hydraulic circuit diagram illustrating a state in which an electric brake system according to an embodiment of the present disclosure operates abnormally.

FIG. 8 is a hydraulic circuit diagram illustrating a state in which an electric brake system according to an embodiment of the present disclosure operates in a dump mode.

FIG. 9 is a hydraulic circuit diagram illustrating a state in which an electric brake system according to an embodiment of the present disclosure operates in an inspection mode.

### DETAILED DESCRIPTION

Hereinafter, embodiments of the present disclosure will be described in detail with reference to the accompanying drawings. The embodiments to be described below are provided to fully convey the spirit of the present disclosure to a person skilled in the art. The present disclosure is not limited to the embodiments disclosed herein and may be implemented in other forms. In the drawings, some portions not related to the description will be omitted and will not be shown in order to clearly describe the present disclosure, and also a size of a component may be somewhat exaggerated to help understanding.

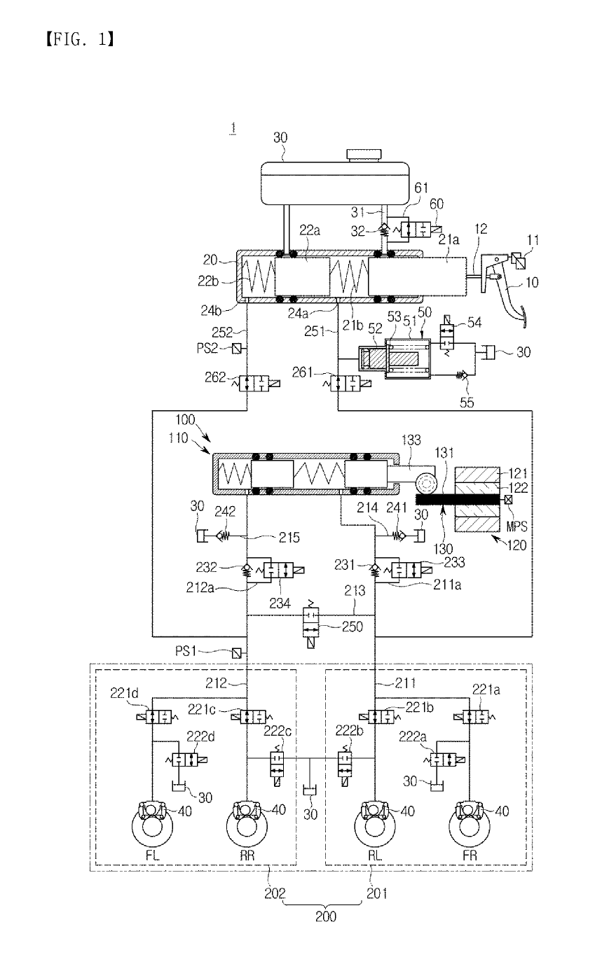

FIG. 1 is a hydraulic circuit diagram illustrating a non-braking state of an electric brake system 1 according to an embodiment of the present disclosure.

Referring to FIG. 1, the electric brake system 1 generally includes a master cylinder 20 for generating hydraulic pressure, a reservoir 30 coupled to an upper part of the master cylinder 20 to store oil, an input rod 12 for pressurizing the master cylinder 20 according to a pedal effort of a brake pedal 10, a wheel cylinder 40 for receiving the hydraulic pressure to perform braking of each of wheels RR, RL, FR, and FL, a pedal displacement sensor 11 for sensing a displacement of the brake pedal 10, and a simulation device 50 for providing a reaction force according to the pedal effort of the brake pedal 10.

The master cylinder 20 may be configured to include at least one chamber to generate hydraulic pressure. As one example, the master cylinder 20 may be configured to include two chambers, a first piston 21a and a second piston 22a may be provided at the two chambers, respectively, and the first piston 21a may be connected to the input rod 12.

Meanwhile, the master cylinder 20 may include two chambers to secure safety when one chamber fails. For example, one of the two chambers may be connected to a front right wheel FR and a rear left wheel RL of a vehicle, and the remaining chamber may be connected to a front left wheel FL and a rear right wheel RR thereof. Alternatively, unlike shown in the drawing, one of the two chambers may be connected to two front wheels FR and FL and the remaining chamber may be connected to two rear wheels RR and RL. As described above, the two chambers may be independently configured so that braking of the vehicle may be possible even when one of the two chambers fails.

For this purpose, the master cylinder 20 may include first and second hydraulic ports 24a and 24b which are formed thereon and through which hydraulic pressure is delivered from each of the two chambers.

Also, a first spring 21b may be provided between the first piston 21a and the second piston 22a of the master cylinder 20, and a second spring 22b may be provided between the second piston 22a and an end of the master cylinder 20.

The first spring 21b and the second spring 22b are provided at the two chambers, respectively, to store an elastic force when the first piston 21a and the second piston 22a are compressed according to a variance of a displacement of the brake pedal 10. Further, when a force pushing the first piston 21a is less than the elastic force, the first spring 21b and the second spring 22b may use the stored elastic force to push the first and second pistons 21a and 22a and return the first and second pistons 21a and 22a to their original positions, respectively.

Meanwhile, the input rod 12 pressurizing the first piston 21a of the master cylinder 20 may come into close contact with the first piston 21a. In other words, no gap may exist between the master cylinder 20 and the input rod 12. Consequently, when the brake pedal 10 is stepped on, the master cylinder 20 may be directly pressurized without a pedal dead stroke section.

The simulation device 50 may be connected to a first backup flow path 251, which will be described below, to provide a reaction force according to a pedal effort of the brake pedal 10. The reaction force may be provided to compensate for a pedal effort provided from a driver such that a braking force may be finely controlled as intended by the driver.

Referring to FIG. 1, the simulation device 50 includes a simulation chamber 51 provided to store oil flowing from the first hydraulic port 24a of the master cylinder 20, a reaction force piston 52 provided inside the simulation chamber 51, a pedal simulator provided with a reaction force spring 53 elastically supporting the reaction force piston 52, and a simulator valve 54 connected to a rear end part of the simulation chamber 51.

The reaction force piston 52 and the reaction force spring 53 are respectively installed to have a predetermined range of displacement within the simulation chamber 51 by means of oil flowing therein.

Meanwhile, the reaction force spring 53 shown in the drawing is merely one embodiment capable of providing an elastic force to the reaction force piston 52, and thus it may include numerous embodiments capable of storing the elastic force through shape deformation. As one example, the reaction force spring 53 includes a variety of members which are configured with a material including rubber and the like and have a coil or plate shape, thereby being able to store an elastic force.

The simulator valve 54 may be provided at a flow path connecting a rear end of the simulation chamber 51 to the reservoir 30. A front end of the simulation chamber 51 may be connected to the master cylinder 20, and the rear end of the simulation chamber 51 may be connected to the reservoir 30 through the simulator valve 54. Therefore, even when the reaction force piston 52 returns, oil inside the reservoir 30 may flow through the simulator valve 54 so that an inside of the simulation chamber 51 is entirely filled with the oil.

Meanwhile, a plurality of reservoirs 30 are shown in the drawing, and the same reference number is assigned to each of the plurality of reservoirs 30. These reservoirs may be configured with the same components, and may alternatively be configured with different components. As one example, the reservoir 30 connected to the simulation device 50 may be the same as the reservoir 30 connected to the master cylinder 20, or may be a storage part capable of storing oil in separation from the reservoir 30 connected to the master cylinder 20.

Meanwhile, the simulator valve 54 may be configured with a normally closed type solenoid valve usually maintaining a closed state. When the driver applies a pedal effort to the brake pedal 10, the simulator valve 54 may be opened to deliver braking oil between the simulation chamber 51 and the reservoir 30.

Also, a simulator check valve 55 may be installed to be connected in parallel with the simulator valve 54 between the pedal simulator and the reservoir 30. The simulator check valve 55 may allow the oil inside the reservoir 30 to flow toward the simulation chamber 51 and may block the oil inside the simulation chamber 51 from flowing toward the reservoir 30 through a flow path at which the simulator check valve 55 is installed. When the pedal effort of the brake pedal 10 is released, the oil may be provided inside the simulation chamber 51 through the simulator check valve 55 to ensure a rapid return of pressure of the pedal simulator.

To describe an operating process of the simulation device 50, when the driver applies a pedal effort to the brake pedal 10, the oil inside the simulation chamber 51, which is pushed by the reaction force piston 52 of the pedal simulator while the reaction force piston 52 compresses the reaction force spring 53, is delivered to the reservoir 30 through the simulator valve 54, and then a pedal feeling is provided to the driver through such an operation. Further, when the driver releases the pedal effort from the brake pedal 10, the reaction force spring 53 may push the reaction force piston 52 to return the reaction force piston 52 to its original state, and the oil inside the reservoir 30 may flow into the simulation chamber 51 through the flow path at which the simulator valve 54 is installed and the flow path at which the simulator check valve 55 is installed, thereby completely filling the inside of the simulation chamber 51 with the oil.

As described above, because the inside of the simulation chamber 51 is in a state in which the oil is filled therein at all times, friction of the reaction force piston 52 is minimized when the simulation device 50 is operated, and thus durability of the simulation device 50 may be improved and also introduction of foreign materials from the outside may be blocked.

The electric brake system 1 according to one embodiment of the present disclosure may include a hydraulic pressure supply device 100 which is mechanically operated by receiving a braking intent of the driver in the form of an electrical signal from the pedal displacement sensor 11 measuring a displacement of the brake pedal 10, a hydraulic control unit 200 configured with first and second hydraulic circuits 201 and 202, each of which is provided at two wheels, and controlling a hydraulic pressure flow delivered to the wheel cylinder 40 that is provided at each of the wheels RR, RL, FR, and FL, a first cut valve 261 provided at the first backup flow path 251 connecting the first hydraulic port 24a to the first hydraulic circuit 201 to control a hydraulic pressure flow, a second cut valve 262 provided at a second backup flow path 252 connecting the second hydraulic port 24b to the second hydraulic circuit 202 to control a hydraulic pressure flow, and an electronic control unit (ECU) (not shown) controlling the hydraulic pressure supply device 100 and valves 54, 60, 221a, 221b, 221c, 221d, 222a, 222b, 222c, 222d, 233, 234, and 250 on the basis of hydraulic pressure information and pedal displacement information.

The hydraulic pressure supply device 100 may include a hydraulic pressure supply unit 110 for providing oil pressure delivered to the wheel cylinder 40, a motor 120 for generating a rotational force in response to an electrical signal of the pedal displacement sensor 11, and a power conversion unit 130 for converting a rotational movement of the motor 120 into a rectilinear movement and transmitting the rectilinear movement to the hydraulic pressure supply unit 110. Alternatively, the hydraulic pressure supply unit 110 may be operated by means of pressure provided from a high pressure accumulator instead of a driving force supplied from the motor 120.

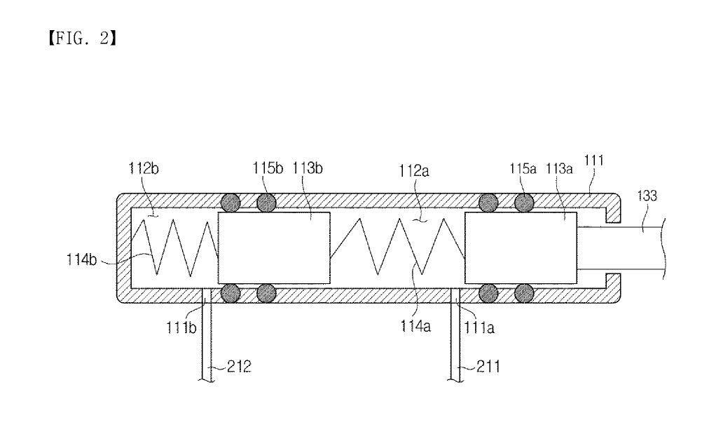

FIG. 2 is a diagram illustrating a structure of the hydraulic pressure supply unit 110.

Referring to FIG. 2, the hydraulic pressure supply unit 110 includes a cylinder block 111 in which a pressure chamber 112 (that is, 112a and 112b) for receiving and storing oil therein is formed, a hydraulic piston 113 (that is, 113a and 113b) accommodated in the cylinder block 111, and a sealing member 115 (that is, 115a and 115b) provided between the hydraulic piston 113 and the cylinder block 111 to seal the pressure chamber 112.

The hydraulic pressure supply unit 110 may be configured to include two or more pressure chambers to generate hydraulic pressure. As one example, the hydraulic pressure supply unit 110 may be configured to include the two pressure chambers 112a and 112b, a first hydraulic piston 113a may be provided in the first pressure chamber 112a and a second hydraulic piston 113b may be provided in the second pressure chamber 112b, and the first hydraulic piston 113a may be connected to a drive shaft 133 of the power conversion unit 130 which will be described.

The first pressure chamber 112a, which is located at a front side (in a forward movement direction, that is, a leftward direction of the drawing) of the first hydraulic piston 113a, may be a space comparted by means of a rear end of the second hydraulic piston 113b, a front end of the first hydraulic piston 113a, and the cylinder block 111. Further, the second pressure chamber 112b located at a front side of the second hydraulic piston 113b may be a space comparted by means of a front end of the second hydraulic piston 113b and the cylinder block 111.

Also, a first hydraulic spring 114a may be provided between the first hydraulic piston 113a and the second hydraulic piston 113b, and a second hydraulic spring 114b may be provided between the second hydraulic piston 113b and an inner surface at a front side of the cylinder block 111.

The first hydraulic spring 114a and the second hydraulic spring 114b are provided at the two pressure chambers 112a and 112b, respectively, to store an elastic force when the first hydraulic piston 113a and the second hydraulic piston 113b are compressed. Further, when a force pushing the first hydraulic piston 113a is less than the elastic force, the first hydraulic spring 114a and the second hydraulic spring 114b may use the stored elastic force to push the first and second hydraulic pistons 113a and 113b and return the first and second hydraulic pistons 113a and 113b to their original positions, respectively.

The sealing member 115 includes a first sealing member 115a provided between the first hydraulic piston 113a and the cylinder block 111 to seal therebetween, and a second sealing member 115b provided between the second hydraulic piston 113b and the cylinder block 111 to seal therebetween.

The first or second sealing member 115a or 115b may be configured with a pair of sealing members that is consecutively disposed. As one example, a ring-shaped sealing member may be disposed such that two sealing members are consecutively disposed in a length direction of the first or second hydraulic piston 113a or 113b.

The sealing member 115 seals the pressure chamber 112 to prevent hydraulic pressure or negative pressure from leaking therefrom. As one example, hydraulic pressure or negative pressure of the first pressure chamber 112a, which is generated while the first hydraulic piston 113a is moved forward or backward, may be blocked by the first and second sealing members 115a and 115b and may be delivered to a first hydraulic flow path 211 without leaking to the outside of the second pressure chamber 112b and the cylinder block 111. Further, hydraulic pressure or negative pressure of the second pressure chamber 112b, which is generated while the second hydraulic piston 113b is moved forward or backward, may be blocked by the second sealing member 115b and may be delivered to a second hydraulic flow path 212 without leaking to the first pressure chamber 112a.

Referring back to FIG. 1, the first pressure chamber 112a is connected to the first hydraulic flow path 211 through a first communicating hole 111a formed at a rear side of the cylinder block 111 (in a backward movement direction, that is, a rightward direction of the drawing). Further, the second pressure chamber 112b is connected to the second hydraulic flow path 212 through a second communicating hole 111b formed at the front side of the cylinder block 111.

Here, the first hydraulic flow path 211 connects the first pressure chamber 112a to the first hydraulic circuit 201, and the second hydraulic flow path 212 connects the second pressure chamber 112b to the second hydraulic circuit 202.

Meanwhile, the electric brake system 1 according to the embodiment of the present disclosure may further include a third hydraulic flow path 213 communicating the first hydraulic flow path 211 and the second hydraulic flow path 212. Further, the third hydraulic flow path 213 may communicate the first hydraulic circuit 201 and the second hydraulic circuit 202.

In addition, the third hydraulic flow path 213 may connect a downstream side of a first control valve 231 at the first hydraulic flow path 211 to a downstream side of a second control valve 232 at the second hydraulic flow path 212.

Moreover, the electric brake system 1 according to the embodiment of the present disclosure may further include a circuit balance valve 250 provided at the third hydraulic flow path 213 to control an oil flow.

The circuit balance valve 250 may be configured with a normally closed type solenoid valve that is usually closed and is open when an opening signal is received from the ECU. That is, the circuit balance valve 250 may control an oil flow in a direction toward the second hydraulic flow path 212 at the first hydraulic flow path 211, whereas it may control an oil flow in a direction toward the first hydraulic flow path 211 at the second hydraulic flow path 212.

The pressure chamber may be connected to the reservoir 30 through dump flow paths 214 and 215, and receive and store oil supplied from the reservoir 30 or deliver oil inside the pressure chamber to the reservoir 30. As one example, the dump flow paths may include a first dump flow path 214 connecting the first pressure chamber 112a to the reservoir 30, and a second dump flow path 215 connecting the second pressure chamber 112b to the reservoir 30.

The first dump flow path 214 may branch from the first hydraulic flow path 211 to communicate with the reservoir 30. Further, the first dump flow path 214 may branch from an upstream side of the first control valve 231. Further, the second dump flow path 215 may branch from the second hydraulic flow path 212 to communicate with the reservoir 30. Further, the second dump flow path 215 may branch from an upstream side of the second control valve 232. Alternatively, unlike shown in the drawing, the first dump flow path 214 may be provided to communicate a communicating hole formed at the first pressure chamber 112a with the reservoir 30, and the second dump flow path 214 may be provided to communicate a communicating hole formed at the second pressure chamber 112b with the reservoir 30.

Also, the electric brake system 1 according to the embodiment of the present disclosure may further include dump valves 241 and 242 which control opening and closing of the dump flow paths 214 and 215. The dump valves 241 and 242 may be configured with a check valve that is able to deliver hydraulic pressure in only one direction, and may allow hydraulic pressure to be delivered from the reservoir 30 to the first or second pressure chamber 112a or 112b and block hydraulic pressure from being delivered from the first or second pressure chamber 112a or 112b to the reservoir 30.

The dump valves include a first dump valve 241 installed at the first dump flow path 214 to control an oil flow, and a second dump valve 242 installed at the second dump flow path 215 to control an oil flow. The dump flow paths 214 and 215, at which the dump valves 241 and 242 are installed, may be used when hydraulic pressure of the first or second pressure chamber 112a or 112b is supplemented.

Also, the hydraulic pressure supply unit 110 of the electric brake system 1 according to the embodiment of the present disclosure may be operated in a tandem manner. That is, hydraulic pressure, which is generated in the first pressure chamber 112a while the first hydraulic piston 113a is moved forward, may be delivered to the first hydraulic circuit 201 to operate the wheel cylinders 40 installed at the rear left wheel RL and the front right wheel FR, and hydraulic pressure, which is generated in the second pressure chamber 112b while the second hydraulic piston 113b is moved forward, may be delivered to the second hydraulic circuit 202 to operate the wheel cylinders 40 installed at the rear right wheel RR and the front left wheel FL.

The motor 120 is a device for generating a rotational force according to a signal output from the ECU (not shown) and may generate the rotational force in a forward or backward direction. An angular velocity and a rotational angle of the motor 120 may be precisely controlled. Because such a motor 120 is generally known in the art, a detailed description thereof will be omitted.

Meanwhile, the ECU controls not only the motor 120 but also the valves 54, 60, 221a, 221b, 221c, 221d, 222a, 222b, 222c, 222d, 233, 234, and 250 provided at the electric brake system 1 of the present disclosure, which will be described below. An operation of controlling a plurality of valves according to a displacement of the brake pedal 10 will be described below.

A driving force of the motor 120 generates a displacement of the first hydraulic piston 113a through the power conversion unit 130, and hydraulic pressure, which is generated while the first hydraulic piston 113a and the second hydraulic piston 113b slide inside the cylinder block 111, is delivered to the wheel cylinder 40 installed at each of the wheels RR, RL, FR, and FL through the first and second hydraulic flow paths 211 and 212.

The power conversion unit 130 is a device for converting a rotational force into a rectilinear movement, and, as one example, may be configured with a worm shaft 131, a worm wheel 132, and the drive shaft 133.

The worm shaft 131 may be integrally formed with a rotational shaft of the motor 120, and rotates the worm wheel 132 engaged therewith and coupled thereto through a worm that is formed on an outer circumferential surface of the worm shaft 131. The worm wheel 132 linearly moves the drive shaft 133 engaged therewith and coupled thereto, and the drive shaft 133 is connected to the first hydraulic piston 113a to slide the first hydraulic piston 113a inside the cylinder block 111.

To describe such operations again, a signal, which is sensed by the pedal displacement sensor 11 when a displacement occurs at the brake pedal 10, is transmitted to the ECU (not shown), and then the ECU operates the motor 120 in one direction to rotate the worm shaft 131 in the one direction. A rotational force of the worm shaft 131 is transmitted to the drive shaft 133 via the worm wheel 132, and then the first hydraulic piston 113a connected to the drive shaft 133 is moved forward to generate hydraulic pressure in the pressure chamber.

On the other hand, when the pedal effort is released from the brake pedal 10, the ECU operates the motor 120 in a reverse direction to reversely rotate the worm shaft 131. Consequently, the worm wheel 132 is also reversely rotated, and then the first hydraulic piston 113a connected to the drive shaft 133 is returned to its original position.

A signal, which is sensed by the pedal displacement sensor 11 when a displacement occurs at the brake pedal 10, is transmitted to the ECU (not shown), and then the ECU activates the motor 120 in one direction to rotate the worm shaft 131 in the one direction. A rotational force of the worm shaft 131 is transmitted to the drive shaft 133 via the worm wheel 132, and then the first hydraulic piston 113a connected to the drive shaft 133 is moved forward to generate hydraulic pressure in the first pressure chamber 112a. Further, the hydraulic pressure of the first pressure chamber 112a may move the second hydraulic piston 113b forward to generate hydraulic pressure in the second pressure chamber 112b.

On the other hand, when the pedal effort is released from the brake pedal 10, the ECU activates the motor 120 in a reverse direction, and thus the worm shaft 131 is reversely rotated. Consequently, the worm wheel 132 is also reversely rotated, and thus negative pressure is generated in the first pressure chamber 112a while the first hydraulic piston 113a connected to the drive shaft 133 is returned to its original position, that is, is moved backward. Further, the negative pressure in the first pressure chamber 112a and the elastic force of the first and second hydraulic springs 114a and 114b may move the second hydraulic piston 113b backward to generate negative pressure in the second pressure chamber 112b.

As described above, the hydraulic pressure supply device 100 serves to deliver the hydraulic pressure to the wheel cylinders 40 or to cause the hydraulic pressure to be discharged therefrom and delivered to the reservoir 30 according to a rotational direction of the rotational force generated from the motor 120.

Although not shown in the drawing, the power conversion unit 130 may be configured with a ball screw nut assembly. For example, the power conversion unit 130 may be configured with a screw which is integrally formed with the rotational shaft of the motor 120 or is connected to and rotated with the rotational shaft thereof, and a ball nut which is screw-coupled to the screw in a state in which a rotation of the ball nut is restricted to perform a rectilinear movement according to a rotation of the screw. The first hydraulic piston 113a is connected to the ball nut of the power conversion unit 130 to pressurize the pressure chamber by means of the rectilinear movement of the ball nut. Such a ball screw nut assembly is a device for converting a rotational movement into a rectilinear movement, and a structure thereof is generally known in the art so that a detailed description thereof will be omitted.

Further, it should be understood that the power conversion unit 130 according to the embodiment of the present disclosure may employ any structure capable of converting a rotational movement into a rectilinear movement in addition to the structure of the ball screw nut assembly.

Also, the electric brake system 1 according to the embodiment of the present disclosure may further include the first and second backup flow paths 251 and 252 capable of directly supplying oil discharged from the master cylinder 20 to the wheel cylinders 40 when the hydraulic pressure supply device 100 operates abnormally.

The first cut valve 261 for controlling an oil flow may be provided at the first backup flow path 251, and the second cut valve 262 for controlling an oil flow may be provided at the second backup flow path 252. Also, the first backup flow path 251 may connect the first hydraulic port 24a to the first hydraulic circuit 201, and the second backup flow path 252 may connect the second hydraulic port 24b to the second hydraulic circuit 202.

Further, the first and second cut valves 261 and 262 may be configured with a normally opened type solenoid valve that is usually open and is closed when a closing signal is received from the ECU.

In addition, the first backup flow path 251 may communicate with the first hydraulic flow path 211, and the second backup flow path 252 may communicate with the second hydraulic flow path 212. Further, the first backup flow path 251 may be connected to the first hydraulic flow path 211 at the downstream side of the first control valve 231, and the second backup flow path 252 may be connected to the second hydraulic flow path 212 at the downstream side of the second control valve 232.

Next, the hydraulic control unit 200 according to the embodiment of the present disclosure will be described with reference to FIG. 1.

The hydraulic control unit 200 may be configured with the first hydraulic circuit 201 and the second hydraulic circuit 202, each of which receives hydraulic pressure to control two wheels. As one example, the first hydraulic circuit 201 may control the front right wheel FR and the rear left wheel RL, and the second hydraulic circuit 202 may control the front left wheel FL and the rear right wheel RR. Further, the wheel cylinder 40 is installed at each of the wheels FR, FL, RR, and RL to perform braking by receiving the hydraulic pressure.

The first hydraulic circuit 201 is connected to the first hydraulic flow path 211 to receive the hydraulic pressure provided from the hydraulic pressure supply device 100, and the first hydraulic flow path 211 branches into two flow paths that are connected to the front right wheel FR and the rear left wheel RL, respectively. Similarly, the second hydraulic circuit 202 is connected to the second hydraulic flow path 212 to receive the hydraulic pressure provided from the hydraulic pressure supply device 100, and the second hydraulic flow path 212 branches into two flow paths that are connected to the front left wheel FL and the rear right wheel RR, respectively.

The hydraulic circuits 201 and 202 may be provided with a plurality of inlet valves 221 (that is, 221a, 221b, 221c, and 221d) to control a hydraulic pressure flow. As one example, two inlet valves 221a and 221b may be provided at the first hydraulic circuit 201 and connected to the first hydraulic flow path 211 to independently control the hydraulic pressure delivered to two of the wheel cylinders 40. Also, two inlet valves 221c and 221d may be provided at the second hydraulic circuit 202 and connected to the second hydraulic flow path 212 to independently control the hydraulic pressure delivered to two of the wheel cylinders 40.

Further, the plurality of inlet valves 221 may be disposed at an upstream side of each of the wheel cylinders 40 and may be configured with a normally opened type solenoid valve that is usually open and is closed when a closing signal is received from the ECU.

Also, the hydraulic control unit 200 may be further provided with a plurality of outlet valves 222 (that is, 222a, 222b, 222c, and 222d) connected to the reservoirs 30 to improve braking release performance when the braking is released. Each of the outlet valves 222 is connected to the wheel cylinder 40 to control discharging of the hydraulic pressure from each of the wheels RR, RL, FR, and FL. That is, when braking pressure of each of the wheels RR, RL, FR, and FL is sensed and a decompression of the braking is determined to be required, the outlet valves 222 may be selectively opened to control the braking pressure.

Further, the outlet valves 222 may be configured with a normally closed type solenoid valve that is usually closed and is open when an opening signal is received from the ECU.

In addition, the hydraulic control unit 200 may be connected to the backup flow paths 251 and 252. As one example, the first hydraulic circuit 201 may be connected to the first backup flow path 251 to receive the hydraulic pressure provided from the master cylinder 20, and the second hydraulic circuit 202 may be connected to the second backup flow path 252 to receive the hydraulic pressure provided from the master cylinder 20.

Consequently, when the first and second cut valves 261 and 262 are switched to a closed state and the plurality of inlet valves 221a, 221b, 221c, and 221d are maintained in an open state, the hydraulic pressure provided from the hydraulic pressure supply device 100 may be supplied to the wheel cylinders 40 through the first and second hydraulic flow paths 211 and 212, and, when the first and second cut valves 261 and 262 are maintained in an open state and the plurality of inlet valves 221a, 221b, 221c, and 221d are maintained in the open state, the hydraulic pressure provided from the master cylinder 20 may be supplied to the wheel cylinders 40 through the first and second backup flow paths 251 and 252.

Meanwhile, an undescribed reference number “PS1” is a hydraulic flow path pressure sensor which senses hydraulic pressure of each of the first and second hydraulic circuits 201 and 202, and an undescribed reference number “PS2” is a backup flow path pressure sensor which senses oil pressure of the master cylinder 20. Further, an undescribed reference number “MPS” is a motor control sensor which controls a rotational angle or a current of the motor 120.

Also, the electric brake system 1 according to the embodiment of the present disclosure may further include an inspection valve 60 that is installed at a flow path 31 connecting the master cylinder 20 to the reservoir 30. As described above, the flow path 31 connecting the master cylinder 20 to the reservoir 30 may be provided to correspond to the number of chambers inside the master cylinder 20.

Hereinafter, one example in which a plurality of flow paths 31, each of which connects the master cylinder 20 to the reservoir 30, are provided and the inspection valve 60 is installed at one of the plurality of flow paths 31 will be described. At this point, the remaining flow paths at which the inspection valve 60 is not installed may be blocked by controlling the valves including the second cut valve 262 and the like.

The flow path 31, which connects the reservoir 30 to a chamber provided between the first piston 21a and the second piston 22a of the master cylinder 20, may be configured with two flow paths connected in parallel with each other. A check valve 32 may be installed at one of the two flow paths connected in parallel with each other, and the inspection valve 60 may be installed at the other thereof.

The check valve 32 is provided to allow hydraulic pressure to be delivered from the reservoir 30 to the master cylinder 20, and to block the hydraulic pressure from being delivered from the master cylinder 20 to the reservoir 30. Further, the inspection valve 60 may be controlled to allow or block the hydraulic pressure that is delivered between the reservoir 30 and the master cylinder 20.

Consequently, when the inspection valve 60 is opened, the hydraulic pressure in the reservoir 30 may be delivered to the master cylinder 20 through the flow path at which the check valve 32 is installed and a flow path 61 at which the inspection valve 60 is installed, and the hydraulic pressure in the master cylinder 20 may be delivered to the reservoir 30 therethrough. Further, when the inspection valve 60 is closed, the hydraulic pressure in the reservoir 30 may be delivered to the master cylinder 20 through the flow path at which the check valve 32 is installed, but the hydraulic pressure in the master cylinder 20 is not delivered to the reservoir 30 through any flow path.

Meanwhile, the electric brake system 1 according to the embodiment of the present disclosure may be provided to usually allow the hydraulic pressure to be bidirectionally delivered between the reservoir 30 and the master cylinder 20, whereas, in an inspection mode, it may be provided to allow the hydraulic pressure to be delivered from the reservoir 30 to the master cylinder 20 but block the hydraulic pressure from being delivered from the master cylinder 20 to the reservoir 30.

Therefore, the inspection valve 60 may be configured with a normally opened type solenoid valve that is usually open and is closed when a closing signal is received.

As one example, the inspection valve 60 is maintained in an open state in a braking mode to allow the hydraulic pressure to be bidirectionally delivered between the reservoir 30 and the master cylinder 20. Further, the inspection valve 60 may be maintained in a closed state in an inspection mode to prevent the hydraulic pressure in the master cylinder 20 from being delivered to the reservoir 30.

The inspection mode is a mode that inspects whether a loss of pressure exists by generating hydraulic pressure at the hydraulic pressure supply device 100 to inspect whether a leak occurs in the simulator valve 54. When the hydraulic pressure discharged from the hydraulic pressure supply device 100 is delivered to the reservoir 30 to cause the loss of pressure, it is difficult to identify whether a leak occurs in the simulator valve 54.

Therefore, in the inspection mode, the inspection valve 60 may be closed and thus a hydraulic circuit connected to the hydraulic pressure supply device 100 may be configured as a closed circuit. That is, the inspection valve 60, the simulator valve 54, the outlet valves 222, and the circuit balance valve 250 are closed and thus the flow paths connecting the hydraulic pressure supply device 100 to the reservoirs 30 are blocked so that the closed circuit may be configured.

In the inspection mode, the electric brake system 1 according to the embodiment of the present disclosure may provide the hydraulic pressure to only the first backup flow path 251, which is connected to the simulation device 50, of the first and second backup flow paths 251 and 252. Therefore, to prevent the hydraulic pressure discharged from the hydraulic pressure supply device 100 from being delivered to the master cylinder 20 through the second backup flow path 252, the second cut valve 262 may be switched to a closed state in the inspection mode.

In the inspection mode, whether a loss of the hydraulic pressure occurs may be determined through a measurement by means of the backup flow path pressure sensor PS2 after the hydraulic pressure is generated in the hydraulic pressure supply device 100. When the measurement result of the backup flow path pressure sensor PS2 indicates no occurrence of loss, a leak of the simulator valve 54 may be determined as not existing, and otherwise, when the measurement result thereof indicates the occurrence of loss, a leak may be determined as existing in the simulator valve 54.

Meanwhile, the inspection mode may be controlled to be executed when a vehicle is stopped or when it is determined that the driver has no intent to accelerate the vehicle.

At this point, when the hydraulic pressure discharged from the hydraulic pressure supply device 100 is provided to the wheel cylinders 40 in the inspection mode, a braking force not intended by the driver is generated. In this case, there is a problem in that acceleration intended by the driver is not realized due to the braking force which has been already provided even when the driver steps on an accelerator pedal (not shown). To prevent such a problem, the inspection mode may be controlled to be executed when a predetermined time passes after the vehicle has been stopped, in a state in which a hand brake is currently operated, or when the driver applies a predetermined braking force to the vehicle.

Also, when it is determined that the drive has an intent to accelerate the vehicle in a state of the inspection mode, the hydraulic pressure of the wheel cylinders 40 may be rapidly eliminated. That is, when the driver operates the accelerator pedal in the state of the inspection mode, the hydraulic pressure supply device 100 may be operated in opposite to an operation performed in the state of the inspection mode so that the hydraulic pressure of the wheel cylinders 40 may be rapidly eliminated. At this point, the outlet valves 222 may also be opened to assist in releasing the hydraulic pressure of the wheel cylinders 40 to the reservoirs 30.

Hereinafter, an operation of the electric brake system 1 according to the embodiment of the present disclosure will be described in detail.

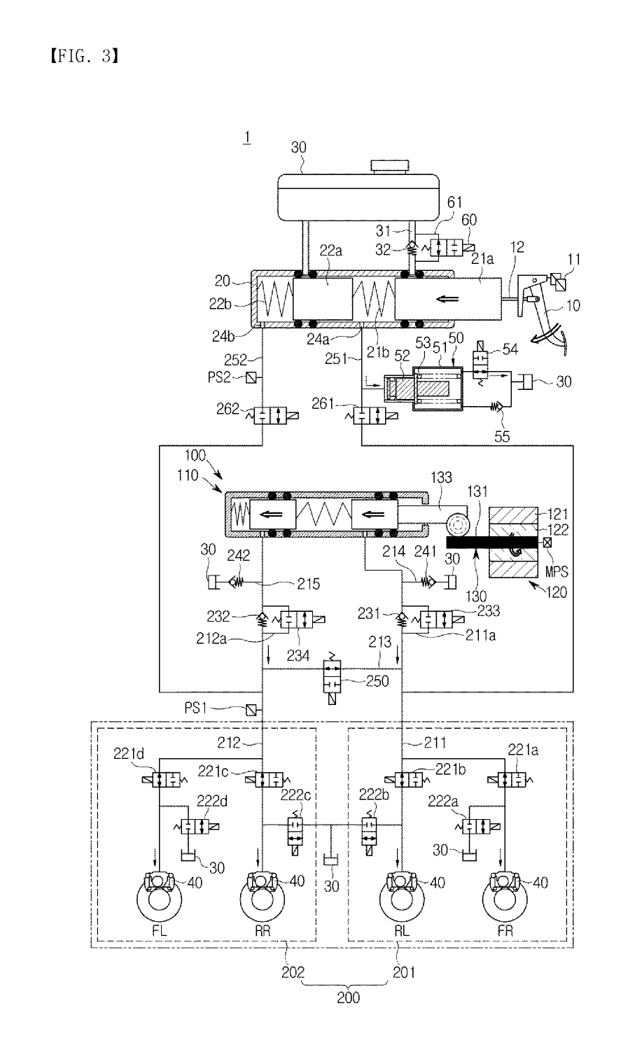

FIG. 3 is a hydraulic circuit diagram illustrating a state in which the electric brake system 1 according to the embodiment of the present disclosure performs a braking operation normally.

When a driver begins braking, an amount of braking requested by the driver may be sensed through the pedal displacement sensor 11 on the basis of information including pressure applied to the brake pedal 10 by the driver or the like. The ECU (not shown) receives an electrical signal output from the pedal displacement sensor 11 to drive the motor 120.

Also, the ECU may receive an amount of regenerative braking through the backup flow path pressure sensor PS2 provided at an outlet side of the master cylinder 20 and the hydraulic flow path pressure sensor PS1 provided at the first and second hydraulic circuits 201 and 202, and may calculate an amount of braking friction based on a difference between the amount of braking requested by the driver and the amount of regenerative braking, thereby determining the magnitude of an increase or reduction of pressure at the wheel cylinder 40.

Referring to FIG. 3, when the driver steps on the brake pedal 10 at an initial stage of braking, the motor 120 is operated to rotate in one direction, a rotational force of the motor 120 is delivered to the hydraulic pressure supply unit 110 by means of the power conversion unit 130, and thus hydraulic pressure is generated in the first pressure chamber 112a and the second pressure chamber 112b while the first hydraulic piston 113a and the second hydraulic piston 113b of the hydraulic pressure supply unit 110 move forward. The hydraulic pressure discharged from the hydraulic pressure supply unit 110 is delivered to the wheel cylinder 40 installed at each of the four wheels through the first hydraulic circuit 201 and the second hydraulic circuit 202 to generate a braking force.

In particular, the hydraulic pressure provided from the first pressure chamber 112a is directly delivered to the wheel cylinders 40 provided at the front right wheel FR and the rear left wheel RL through the first hydraulic flow path 211 connected to the first communicating hole 111a. At this point, the first inlet valve 221a and the second inlet valve 221b, which control the two flow paths branching from the first hydraulic flow path 211, are maintained in the open state. The first and second outlet valves 222a and 222b installed at flow paths respectively branching from the two flow paths, which branch from the first hydraulic flow path 211, are maintained in a closed state to prevent the hydraulic pressure from leaking into the reservoirs 30.

Also, the hydraulic pressure provided from the second pressure chamber 112b is directly delivered to the wheel cylinders 40 provided at the rear right wheel RR and the front left wheel FL through the second hydraulic flow path 212 connected to the second communicating hole 111b. At this point, the third inlet valve 221c and the fourth inlet valve 221d, which control opening and closing of the two flow paths branching from the second hydraulic flow path 212, are maintained in the open state. The third and fourth outlet valves 222c and 222d installed at flow paths respectively branching from two flow paths, which branch from the second hydraulic flow path 212, are maintained in a closed state to prevent the hydraulic pressure from leaking to the reservoirs 30.

Also, when the hydraulic pressure is generated at the hydraulic pressure supply device 100, the first and second cut valves 261 and 262, which are installed at the first and second backup flow paths 251 and 252 connected to the first and second hydraulic ports 24a and 24b of the master cylinder 20, are closed so that the hydraulic pressure discharged from the master cylinder 20 is not delivered to the wheel cylinders 40. Similarly, the first and second cut valves 261 and 262 are closed so that the hydraulic pressure generated at the hydraulic pressure supply device 100 is not delivered to the master cylinder 20.

In addition, the pressure generated by means of a pressurization of the master cylinder 20 according to the pedal effort of the brake pedal 10 is delivered to the simulation device 50 connected to the master cylinder 20. At this point, the normally closed type simulator valve 54 arranged at the rear end of the simulation chamber 51 is opened so that the oil filled in the simulation chamber 51 is delivered to the reservoir 30 through the simulator valve 54. Also, the reaction force piston 52 is moved, and pressure corresponding to a reaction force of the reaction force spring 53 supporting the reaction force piston 52 is generated inside the simulation chamber 51 to provide an appropriate pedal feeling to the driver.

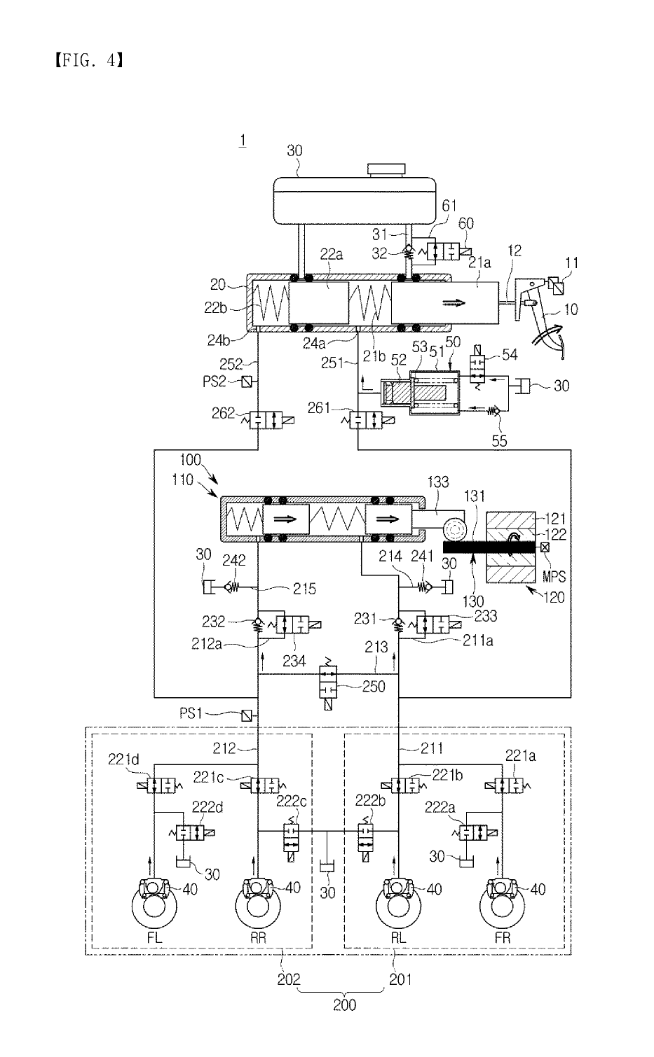

Next, a case of releasing the braking force in a braking state established when the electric brake system 1 according to the embodiment of the present disclosure operates normally will be described. FIG. 4 is a hydraulic circuit diagram illustrating a state in which braking is released while the electric brake system 1 according to the embodiment of the present disclosure operates normally.

Referring to FIG. 4, when a pedal effort applied to the brake pedal 10 is released, the motor 120 generates a rotational force in a reverse direction compared to that of when the braking operation is performed to deliver the generated rotational force to the power conversion unit 130, and the worm shaft 131, the worm wheel 132, and the drive shaft 133 of the power conversion unit 130 are rotated in a reverse direction compared to that of when the braking operation is performed to move the first hydraulic piston 113a and the second hydraulic piston 113b backward and return the first hydraulic piston 113a and the second hydraulic piston 113b to their original positions, thereby releasing the pressure of the first pressure chamber 112a and the second pressure chamber 112b, or forming negative pressure therein. Further, the hydraulic pressure supply unit 110 receives the hydraulic pressure discharged from the wheel cylinder 40 through the first and second hydraulic circuits 201 and 202 to deliver the received hydraulic pressure to the first pressure chamber 112a and the second pressure chamber 112b.

In particular, the negative pressure formed in the first pressure chamber 112a is directly delivered to the wheel cylinders 40 provided at the front right wheel FR and the rear left wheel RL through the first hydraulic flow path 211 connected to the first communicating hole 111a to release the braking force. At this point, the first inlet valve 221a and the second inlet valve 221b which control opening and closing of the two flow paths branching from the first hydraulic flow path 211 are maintained in the open state. Also, the first and second outlet valves 222a and 222b installed at the flow paths respectively branching from the two flow paths, which branch from the first hydraulic flow path 211, are maintained in the closed state.

Also, the negative pressure provided from the second pressure chamber 112b is directly delivered to the wheel cylinders 40 provided at the rear right wheel RR and the front left wheel FL through the second hydraulic flow path 212 connected to the second communicating hole 111b to release the braking force. At this point, the third inlet valve 221c and the fourth inlet valve 221d, which control opening and closing of the two flow paths branching from the second hydraulic flow path 212, are maintained in the open state. In addition, the third and fourth outlet valves 222c and 222d installed at the flow paths respectively branching from the two flow paths, which branch from the second hydraulic flow path 212, are maintained in the closed state.

Also, when the negative pressure is generated at the hydraulic pressure supply device 100, the first and second cut valves 261 and 262, which are installed at the first and second backup flow paths 251 and 252 connected to the first and second hydraulic ports 24a and 24b of the master cylinder 20, are closed so that the negative pressure generated in the master cylinder 20 is not delivered to the wheel cylinder 40. Similarly, the first and second cut valves 261 and 262 are closed so that the negative pressure generated at the hydraulic pressure supply device 100 does not leak into the master cylinder 20.

Meanwhile, in the simulation device 50, the oil in the simulation chamber 51 is delivered to the master cylinder 20 according to the return of the reaction force piston 52 to its original position by means of the elastic force of the reaction force spring 53, and the oil is refilled in the simulation chamber 51 through the simulator valve 54 and the simulator check valve 55 which are connected to the reservoir 30 to assure a rapid return of pressure of the pedal simulator.

Further, the electric brake system 1 according to the embodiment of the present disclosure may control the valves 221a, 221b, 221c, 221d, 222a, 222b, 222c, 222d, 233, 234, and 250 provided at the hydraulic control unit 200 according to pressure required for the wheel cylinder 40 provided at each of the wheels RR, RL, FR, and FL of the two hydraulic circuits 201 and 202, thereby specifying and controlling a control range.

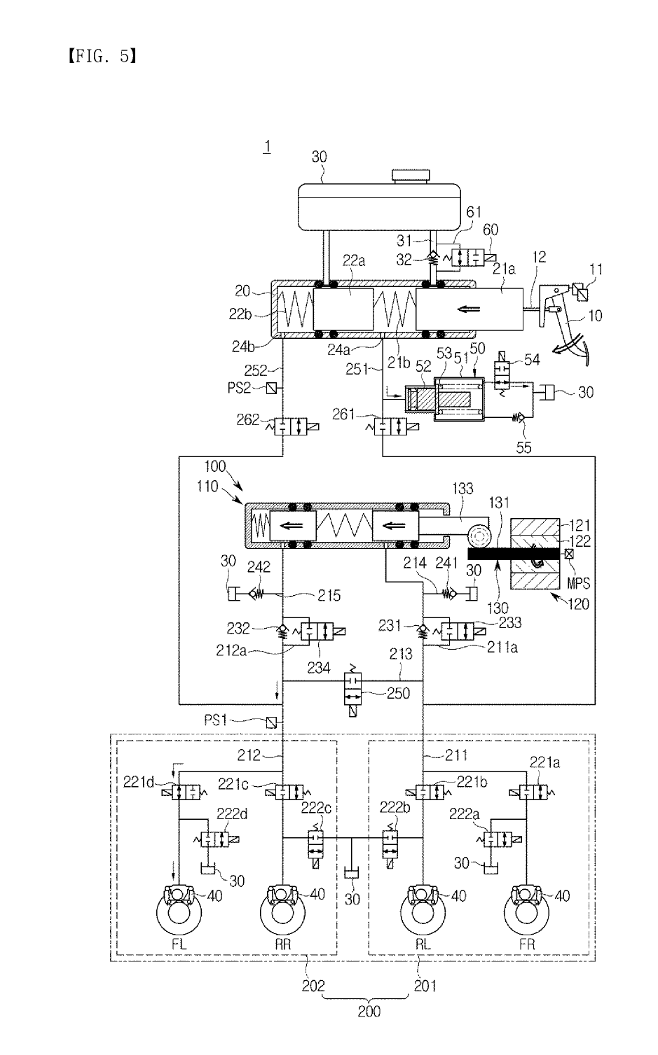

FIG. 5 is a hydraulic circuit diagram illustrating a state in which an anti-lock brake system (ABS) is operated through the electric brake system 1 according to the embodiment of the present disclosure. FIG. 5 illustrates a case in which only corresponding wheel cylinder 40 performs a braking operation while an ABS is operated.

When the motor 120 is operated according to a pedal effort of the brake pedal 10, a rotational force of the motor 120 is transmitted to the hydraulic pressure supply unit 110 through the power conversion unit 130, thereby generating hydraulic pressure. At this point, the first and second cut valves 261 and 262 are closed and thus the hydraulic pressure discharged from the master cylinder 20 is not delivered to the wheel cylinders 40.

Referring to FIG. 5, hydraulic pressure is generated in the first pressure chamber 112a and the second pressure chamber 112b while the first hydraulic piston 113a and the second hydraulic piston 113b are moved forward, the fourth inlet valve 221d is switched to an open state, and thus the hydraulic pressure delivered through the second hydraulic flow path 212 activates the wheel cylinder 40 located at the rear right wheel RR to generate a braking force.

At this point, the first to third inlet valves 221a, 221b, and 221c are switched to a closed state and the first to fourth outlet valves 222a, 222b, 222c, and 222d are maintained in the closed state. Further, the first and second cut valves 261 and 262 are switched to a closed state to prevent the hydraulic pressure generated at the hydraulic pressure supply unit 110 from leaking into the master cylinder 20.

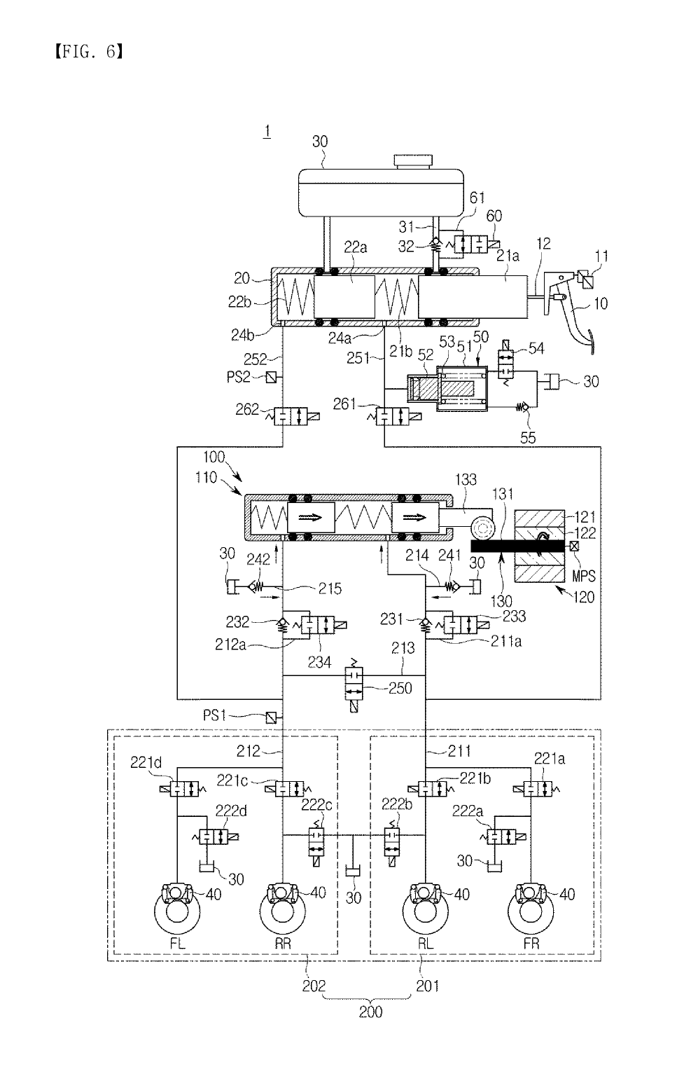

FIG. 6 is a hydraulic circuit diagram illustrating a state in which the electric brake system 1 according to the embodiment of the present disclosure supplements hydraulic pressure.

While the hydraulic pressure of the pressure chamber 112 is delivered to the wheel cylinders 40, the hydraulic pressure inevitably decreases. In such a circumstance, this may be dangerous in that a strong braking force as intended by a driver may not be delivered to the wheel cylinders 40 when a situation requiring the strong braking force occurs. Therefore, a supplement mode which maintains hydraulic pressure in the pressure chamber 112 at a predetermined level is needed.

Referring to FIG. 6, a supplement mode is executed in a state in which a braking operation is not performed. As one example, when a braking operation is not performed for a predetermined time, the supplement mode may be executed.

In the supplement mode, the first to fourth inlet valves 221a, 221b, 221c, and 221d, and the first and second cut valves 261 and 262 are switched to a closed state, and the first to fourth outlet valves 222a, 222b, 222c, and 222d are maintained in the closed state.

In such a state, the motor 120 is reversely operated to return the first hydraulic piston 113a and the second hydraulic piston 113b to their original positions. As a result, negative pressure is formed in the first pressure chamber 112a and the second pressure chamber 112b and oil flows into the first pressure chamber 112a and the second pressure chamber 112b through the dump flow paths 214 and 215 such that hydraulic pressure is supplemented.

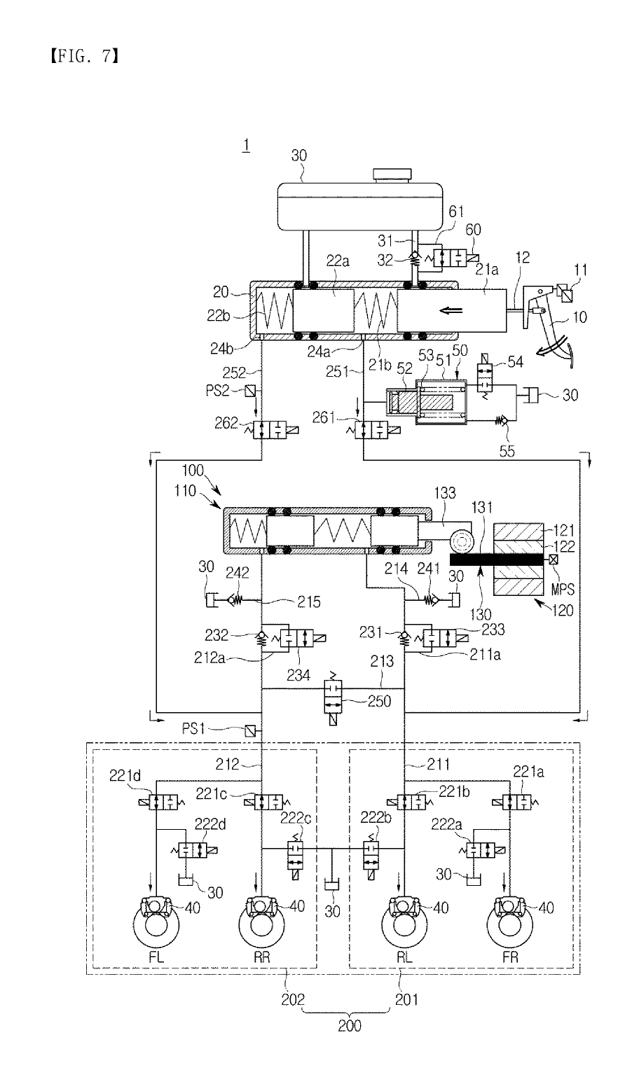

Next, a case in which such an electric brake system 1 operates abnormally will be described. FIG. 7 is a hydraulic circuit diagram illustrating a state in which the electric brake system 1 according to the embodiment of the present disclosure operates abnormally.

Referring to FIG. 7, when the electric brake system 1 operates abnormally, each of the valves 54, 60, 221a, 221b, 221c, 221d, 222a, 222b, 222c, 222d, 233, 234, and 250 is provided in an initial state of braking, that is, a non-operating state. When a driver pressurizes the brake pedal 10, the input rod 12 connected to the brake pedal 10 is moved forward, and at the same time, the first piston 21a, which is in contact with the input rod 12, is moved forward and the second piston 22a is also moved forward by means of the pressurization or movement of the first piston 21a. At this point, because there is no gap between the input rod 12 and the first piston 21a, the braking may be rapidly performed.

Further, the hydraulic pressure discharged from the master cylinder 20 is delivered to the wheel cylinders 40 through the first and second backup flow paths 251 and 252 and the first and second hydraulic flow paths 211 and 212 to realize a braking force.

At this point, the first and second cut valves 261 and 262 respectively installed at the first and second backup flow paths 251 and 252, and the first to fourth inlet valves 221a, 221b, 221c, and 221d are configured with a normally open type solenoid valve, and the simulator valve 54, third and fourth control valves 233 and 234, the circuit balance valve 250, and the first to fourth outlet valves 222a, 222b, 222c, and 222d are configured with a normally closed type solenoid valve so that the hydraulic pressure is directly delivered to the four wheel cylinders 40. Therefore, braking is stably realized to improve braking safety. Alternatively, even when the circuit balance valve 250 is provided in an open state, the hydraulic pressure of the master cylinder 20 may be delivered to the four wheel cylinders 40.

Meanwhile, because the simulator check valve 55 allows only an oil flow flowing from the reservoir 30, the hydraulic pressure discharged from the master cylinder 20 does not leak while a backup braking is performed.

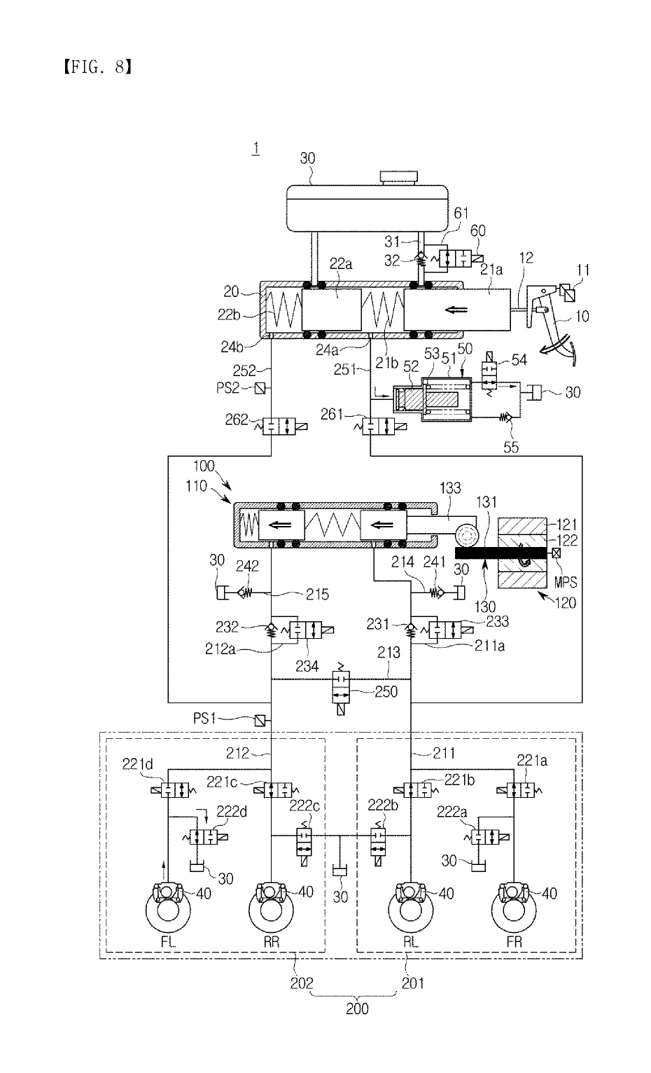

FIG. 8 is a hydraulic circuit diagram illustrating a state in which the electric brake system 1 according to the embodiment of the present disclosure operates in a dump mode.

The electric brake system 1 according to the embodiment of the present disclosure may discharge braking pressure provided only to corresponding wheel cylinders 40 through the first to fourth outlet valves 222a, 222b, 222c, and 222d.

Referring to FIG. 8, when the fourth inlet valve 221d is switched to a closed state, the first to third outlet valves 222a, 222b, and 222c are maintained in the closed state, and when the fourth outlet valve 222d is switched to the open state, the hydraulic pressure discharged from the wheel cylinder 40 installed at the front left wheel FL is discharged to the reservoir 30 through the fourth outlet valve 222d.

As described above, each of the valves 221a, 221b, 221c, 221d, 222a, 222b, 222c, 222d, 233, 234, and 250 of the hydraulic control unit 200 may be independently controlled to selectively deliver or discharge the hydraulic pressure to the wheel cylinder 40 of each of the wheels RL, RR, FL, and FR such that a precise control of the hydraulic pressure may be possible.

Meanwhile, as described above, when the electric brake system 1 operates abnormally, each of the valves 54, 60, 221a, 221b, 221c, 221d, 222a, 222b, 222c, 222d, 233, 234, and 250 is provided in the initial stage of braking, that is, a non-operating state, and the first and second cut valves 261 and 262 installed at the first and second backup flow paths 251 and 252 and each of the inlet valves 221 provided at an upstream side of each of the wheels RR, RL, FR, and FL are opened so that the hydraulic pressure is directly delivered to the wheel cylinders 40.

At this point, the simulator valve 54 is provided in a closed state so that the hydraulic pressure delivered to the wheel cylinders 40 through the first backup flow path 251 is prevented from leaking into the reservoir 30 through the simulation device 50.

Therefore, the driver steps on the brake pedal 10 so that the hydraulic pressure discharged from the master cylinder 20 is delivered to the wheel cylinders 40 without a loss to ensure stable braking.

However, when a leak occurs at the simulator valve 54, a portion of the hydraulic pressure discharged from the master cylinder 20 may be lost to the reservoir 30 through the simulator valve 54. The simulator valve 54 is provided to be closed in an abnormal mode, and the hydraulic pressure discharged from the master cylinder 20 pushes the reaction force piston 52 of the simulation device 50 so that a leak may occur at the simulator valve 54 by means of pressure formed at the rear end of the simulation chamber 51.

As such, when the leak occurs at the simulator valve 54, a braking force may not be obtained as intended by the driver. Consequently, there is a problem in safety of braking.

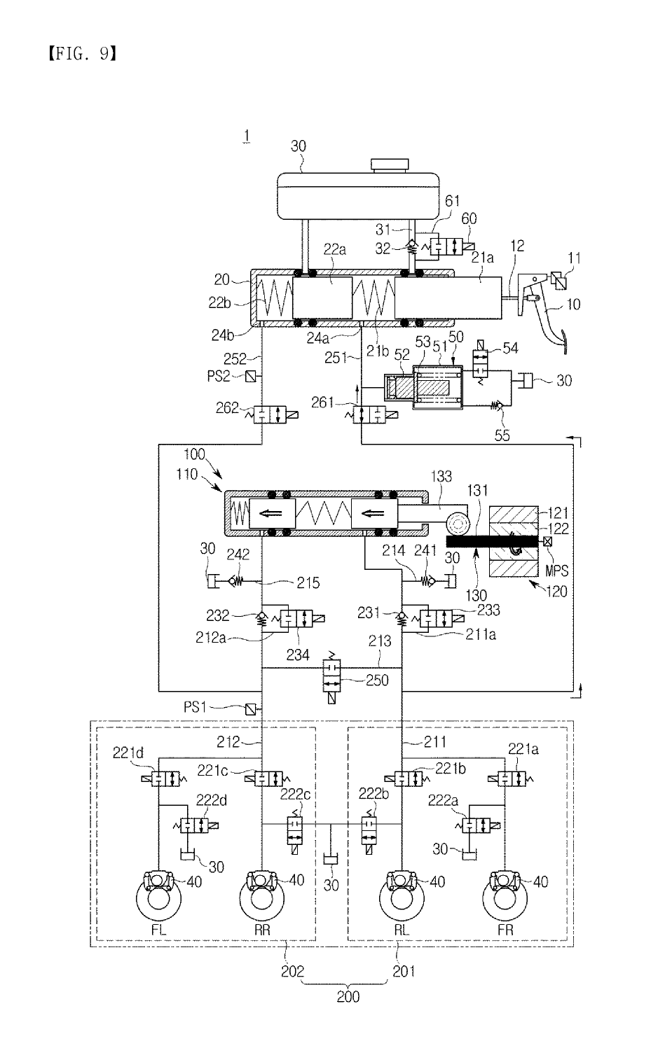

FIG. 9 is a hydraulic circuit diagram illustrating a state in which the electric brake system 1 according to the embodiment of the present disclosure operates in an inspection mode.

The inspection mode is a mode that inspects whether a loss of pressure exists by generating hydraulic pressure at the hydraulic pressure supply device 100 to inspect whether a leak occurs in the simulator valve 54. When the hydraulic pressure discharged from the hydraulic pressure supply device 100 is delivered to the reservoir 30 to cause a loss of pressure, it is difficult to verify whether a leak occurs at the simulator valve 54.

Therefore, in the inspection mode, the inspection valve 60 may be closed and thus a hydraulic circuit connected to the hydraulic pressure supply device 100 may be configured as a closed circuit. That is, the inspection valve 60, the simulator valve 54, the third and fourth control valves 233 and 234, and the outlet valves 222 are closed and thus the flow paths connecting the hydraulic pressure supply device 100 to the reservoirs 30 are blocked so that the closed circuit may be configured. Alternatively, the inlet valves 221 may be switched to a closed state. In this case, the hydraulic pressure is not delivered to the wheel cylinders 40 and thus the inspection mode may be executed even when a vehicle is running.

In the inspection mode, the electric brake system 1 according to one embodiment of the present disclosure may provide the hydraulic pressure to only the first backup flow path 251, which is connected to the simulation device 50, of the first and second backup flow paths 251 and 252. Therefore, to prevent the hydraulic pressure discharged from the hydraulic pressure supply device 100 from being delivered to the master cylinder 20 along the second backup flow path 252, the second cut valve 262 may be maintained in the closed state in the inspection mode.

Referring to FIG. 9, in the inspection mode, at the initial state of the valves 54, 60, 221a, 221b, 221c, 221d, 222a, 222b, 222c, 222d, 233, 234, and 250 provided at the electric brake system 1 of the present disclosure, the first cut valve 261 may be switched to an open state so that the hydraulic pressure generated at the first pressure chamber 112a may be delivered to the master cylinder 20.

In the inspection mode, after generating the hydraulic pressure at the hydraulic pressure supply device 100, the ECU may analyze a signal transmitted from the backup flow path pressure sensor PS2 measuring oil pressure of the master cylinder 20 to sense whether a leak occurs at the simulator valve 54.

When there is no loss on the basis of the measurement result of the backup flow path pressure sensor PS2, the simulator valve 54 may be determined to have no leak, and when the loss occurs, the simulator valve 54 may be determined to have a leak.

As is apparent from the above description, the electric brake system according to the embodiments of the present disclosure is capable of more rapidly providing hydraulic pressure and more precisely controlling an increase of pressure by providing a plurality of pistons of a hydraulic pressure supply device to configure a tandem structure.

Also, an inspection valve capable of allowing and blocking a supply of hydraulic pressure between a reservoir and a master cylinder is employed, thereby inspecting whether a leak occurs at a valve in a circuit.

[Description of Reference Numerals]

| | |
|---|---|
| 10: Brake Pedal | 11: Pedal Displacement Sensor |
| 20: Master Cylinder | 30: Reservoir |
| 40: Wheel Cylinder | 50: Simulation Device |
| 54: Simulator Valve | 60: Inspection Valve |
| 100: Hydraulic Pressure Supply | 110: Hydraulic Pressure Supply |
| Device | Unit |
| 120: Motor | 130: Power Conversion Unit |
| 200: Hydraulic Control Unit | 201: First Hydraulic Circuit |
| 202: Second Hydraulic Circuit | 211: First Hydraulic Flow Path |
| 212: Second Hydraulic Flow Path | 213: Third Hydraulic Flow Path |
| 214: First Dump Flow Path | 215: Second Dump Flow Path |
| 221: Inlet Valve | 222: Outlet Valve |
| 231: First Control Valve | 232: Second Control Valve |
| 233: Third Control Valve | 234: Fourth Control Valve |
| 234: Fourth Dump Valve | 250: Circuit Balance Valve |
| 251: First Backup Flow Path | 252: Second Backup Flow Path |
| 261: First Cut Valve | 262: Second Cut Valve |

What is claimed is:

1. An electric brake system comprising:
a master cylinder at which first and second hydraulic ports are formed, connected to a reservoir configured to store oil, and having one or more pistons to discharge oil according to a pedal effort of a brake pedal;
a pedal displacement sensor configured to sense a displacement of the brake pedal;
a hydraulic pressure supply device configured to generate hydraulic pressure using a piston which is operated by means of an electrical signal that is output corresponding to the displacement of the brake pedal, and including a cylinder block, first and second pistons movably accommodated inside the cylinder block, a first pressure chamber provided at a front side of the first piston and connected to one or more wheel cylinders, and a second pressure chamber provided at a front side of the second piston and connected to the one or more wheel cylinders;
a first hydraulic flow path configured to communicate with the first pressure chamber;
a second hydraulic flow path configured to communicate with the second pressure chamber;
a first control valve provided at the first hydraulic flow path and configured to control an oil flow;
a second control valve provided at the second hydraulic flow path and configured to control an oil flow;
a first hydraulic circuit including first and second branching flow paths which branch from the first hydraulic flow path and are connected to two wheel cylinders, respectively;
a second hydraulic circuit including third and fourth branching flow paths which branch from the second hydraulic flow path and are connected to two wheel cylinders, respectively;
a first backup flow path configured to communicate the first hydraulic port with the first hydraulic flow path and connected to a downstream side of the first control valve;
a second backup flow path configured to communicate the second hydraulic port with the second pressure chamber and connected to a downstream side of the second control valve;
a first cut valve provided at the first backup flow path and configured to control an oil flow;
a second cut valve provided at the second backup flow path and configured to control an oil flow; and
a simulation device provided at a flow path branching from the first backup flow path, configured with a simulator valve provided at a flow path connecting a simulation chamber configured to store oil therein to the reservoir, and configured to provide a reaction force according to the pedal effort of the brake pedal.

2. The electric brake system of claim 1, further comprising:
a first inlet valve provided at the first branching flow path and configured to control an oil flow;
a second inlet valve provided at the second branching flow path and configured to control an oil flow;
a third inlet valve provided at the third branching flow path and configured to control an oil flow; and
a fourth inlet valve provided at the fourth branching flow path and configured to control an oil flow.

3. The electric brake system of claim 2, wherein the first to fourth inlet valves are configured with a solenoid valve configured to control bidirectionally an oil flow between the hydraulic pressure supply device and the one or more wheel cylinders.

4. The electric brake system of claim 3, wherein the first to fourth inlet valves are a normally opened type valve that is usually open and is closed when a closing signal is received.

5. The electric brake system of claim 1, wherein the first control valve is configured with a check valve configured to allow an oil flow in a direction from the first pressure chamber toward the first hydraulic circuit and block an oil flow in a reverse direction, and the second control valve is configured with a check valve configured to allow an oil flow in a direction from the second pressure chamber toward the second hydraulic circuit and block an oil flow in a reverse direction.

6. The electric brake system of claim 1, further comprising:
a first dump flow path configured to communicate with the first pressure chamber and connected to the reservoir;
a second dump flow path configured to communicate with the second pressure chamber and connected to the reservoir;
a first dump valve provided at the first dump flow path, configured to control an oil flow, and configured with a check valve configured to allow an oil flow in a direction from the reservoir to the first pressure chamber and block an oil flow in a reverse direction; and
a second dump valve provided at the second dump flow path, configured to control an oil flow, and configured with a check valve configured to allow an oil flow in a direction from the reservoir to the second pressure chamber and block an oil flow in a reverse direction.

7. The electric brake system of claim 6, wherein the first dump flow path branches from an upstream side of the first control valve at the first hydraulic flow path, and the second dump flow path branches from an upstream side of the second control valve at the second hydraulic flow path.

8. The electric brake system of claim 5, further comprising:
a third control valve provided at a bypass flow path connecting an upstream side of the first control valve and a downstream side thereof at the first hydraulic flow path and configured with a solenoid valve configured to control bidirectionally an oil flow between the first pressure chamber and the first hydraulic circuit; and
a fourth control valve provided at a bypass flow path connecting an upstream side of the second control valve and a downstream side thereof at the second hydraulic flow path and configured with a solenoid valve configured to control bidirectionally an oil flow between the second pressure chamber and the second hydraulic circuit.

9. The electric brake system of claim 8, wherein the third and fourth control valves are a normally closed type valve that is usually closed and is open when an opening signal is received.

10. The electric brake system of claim 1, further comprising:
a third hydraulic flow path configured to communicate the first hydraulic flow path and the second hydraulic flow path and connect a downstream side of the first control valve to a downstream side of the second control valve; and
a circuit balance valve provided at the third hydraulic flow path and configured to control an oil flow.

11. The electric brake system of claim 10, wherein the circuit balance valve is configured with a solenoid valve configured to control bidirectionally an oil flow between the first hydraulic flow path and the second hydraulic flow path.

12. The electric brake system of claim 11, wherein the circuit balance valve is a normally closed type valve that is usually closed and is open when an opening signal is received.
